(19) United States
(12) Patent Application Publication
(10) Pub. No.: US 2011/0186358 A1
(43) Pub. Date: Aug. 4, 2011

(54) Weighing Device

(75) Inventor: Erwin Hihn, Walddorfhaeslach (DE)

(73) Assignee: EISENMANN AG, Boeblingen (DE)

(21) Appl. No.: 13/061,681

(22) PCT Filed: Aug. 22, 2009
(86) PCT No.: PCT/EP2009/006104

§ 371 Date: Mar. 1, 2011

(30) Foreign Application Priority Data
Sep. 4, 2008 (DE) 10 2008 045 762.0

(51) Int. Cl. G01G 1/18

(52) U.S. Cl. 177/246

(57) ABSTRACT

The invention relates to a device for continuously weighing powdered media in a tank, particularly paint powder in a storage tank, comprising a weighing unit having a measurement field on which a compressive force can be exerted, and by which an output signal representing the compressive force exerted on the measurement field can be generated. A guiding device allows forced motion of the tank having a vertical directional component. The tank can further be coupled to the weighing unit by forces by means of a coupling device, so that a compressive force that is dependent on the weight of the tank acts on the measurement field of the weighing unit when the tank is coupled to the weighing unit.

The invention relates to a device for continuously weighing powdered media in a tank, particularly paint powder in a storage tank, having a weighing unit which has a measuring field on which a compressive force can be exerted and by means of which an output signal representing the compressive force exerted on the measuring field may be generated.

Weighing devices of this type are used for example in powder delivery systems for surface engineering in the automobile industry when monitoring the delivery of paint powder with which vehicle bodies are coated. In this case, the tank is a storage tank which is fed with paint powder from a reservoir and from which paint powder is delivered to an application device, for example a rotary sprayer, or other consumer. To this end, the paint powder is fluidised inside the storage tank in a manner known per se, which enables it to flow.

In continuous operation of a powder delivery system of this type, the quantity of paint powder located in the storage tank decreases steadily. When the quantity of paint powder in the storage tank finally reaches a lower threshold value, fresh paint powder has to be supplied to the storage tank in order to ensure continuous operation of the powder delivery system and therefore the coating system in which the powder delivery system is used.

The reaching or falling below of this threshold value is normally monitored by continuously, or at least repeatedly, weighing the storage tank with a device of the type mentioned at the outset. In weighing devices which are known in the market, three load cells on which the storage tank rests are used. In order to ensure that the application of pressure on the load cells is as uniform as possible and thereby achieve a sufficiently precise measuring result, the load cells are arranged at the same angular spacing from one another on a circle. The quantity of paint powder present in the storage tank is determined in real time by establishing the mean value of the three weights determined by the load cells, and the previously determined, and therefore known, tare weight of the storage tank is deducted from this mean value.

As a result of the necessary averaging of the measuring results of all the load cells, the measuring result in the known weighing device is subject to imprecision which can be demonstrated for example in the standard deviation.

The object of the present invention is to provide a weighing device of the type mentioned at the outset, in which the precision when monitoring the quantity of powder located in a tank is increased with a relatively simple construction.

In a weighing device of the type mentioned at the outset, this object is achieved in that it comprises:
a) a guide device which enables a positively driven movement of the tank with a vertical directional component;
b) a coupling device by means of which the tank may be coupled in terms of force to the weighing unit so that a compressive force which is dependent on the weight of the tank acts on the measuring field of the weighing unit when the tank is coupled to the weighing unit.

As a result of these inventive measures, it is possible to determine the weight of the tank with the aid of a single weighing unit. There is therefore no need to establish a mean value from a plurality of measured values, which therefore increases the precision of the weighing result.

As a result of the guide device, the tank to be weighed is protected against tilting although it can be moved in the vertical direction. The vertical degree of freedom for the tank is necessary so that it can exert a weight force of greater or lesser strength vertically downwards depending on its fill level.

As a result of the coupling device, the weight force exerted by the tank to be weighed is transferred to the weighing unit. This generates an output signal which represents the weight determined in each case. After deducting the known tare weight of the tank to be weighed and possibly the weight which acts on the weighing unit from the coupling device, it is thus possible to calculate the quantity of the powdered medium located in the tank from this determined weight.

It is favourable here if the coupling device or the guide device comprises a holding device for the tank.

A simple construction is possible if the coupling device is constructed as a substantially rigid structural unit and the guide device of the coupling device enables the positively driven movement. In this case, the coupling unit is connected to the tank by way of the holding device so that the coupling device and the tank to be weighed can be measured as a single unit by the weighing unit.

It has proven particularly favourable if the guide device provides parallelogram guidance. It is thus particularly possible with the use of low-friction bearings to provide a guide device in which only low frictional forces counteract the movement of the tank and the weight force of the tank can be transferred to the weighing unit in more or less unaffected manner.

It is advantageous if the coupling unit comprises a coupling element which bears on the measuring field of the weighing unit by way of a bearing portion, particularly with a point-shaped bearing surface. This enables a more precise transference of the weight force exerted by the tank to be weighed to the weighing unit.

It has proven advantageous here if the bearing portion of the coupling element is curved and preferably hemispherical. In this case, the coupling device can also tilt to a certain extent in relation to a vertical axis without this having a negative effect on the measuring result of the weighing unit. Such tilting movements can be caused for example by vibrations during operation.

If the weighing unit is a double bending beam load cell, it is advantageously possible to resort to existing and established weighing techniques.

An exemplary embodiment of the invention is explained in more detail below with reference to the drawing, which shows:

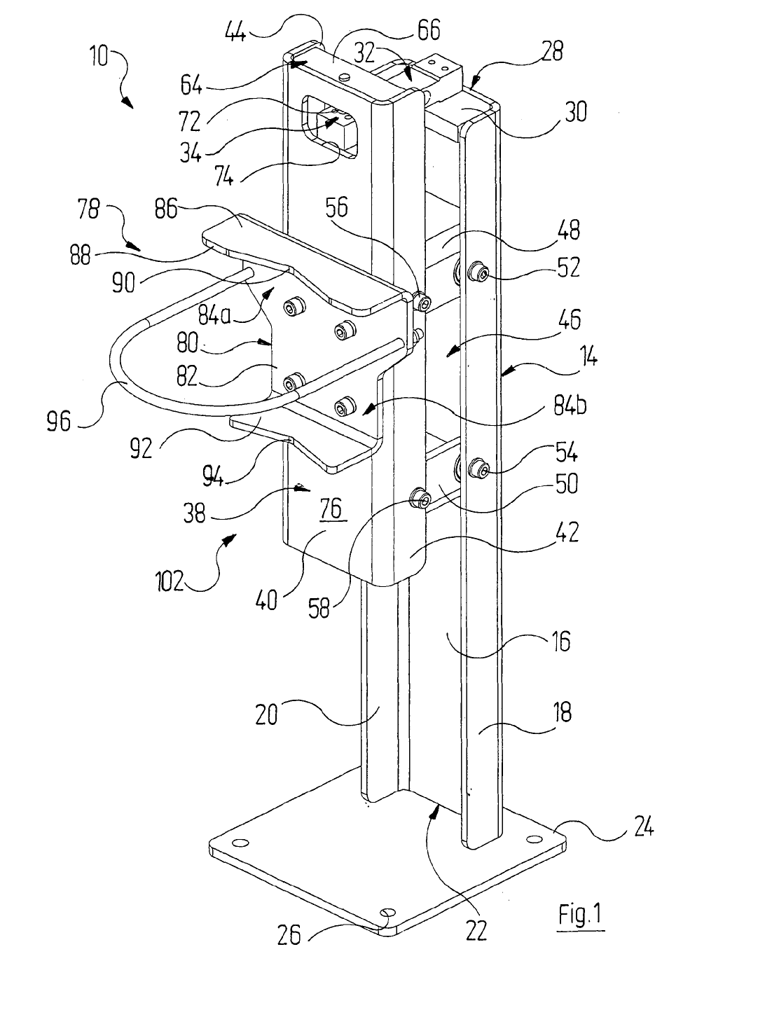

FIG. 1 a perspective view of a weighing device according to the invention;

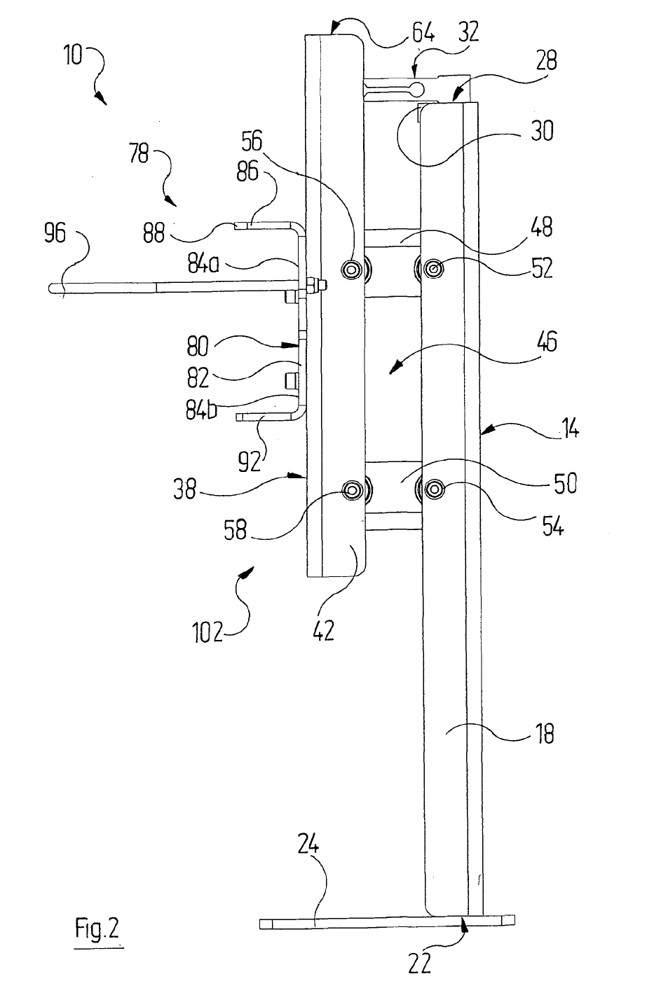

FIG. 2 a side view of the weighing device according to FIG. 1;

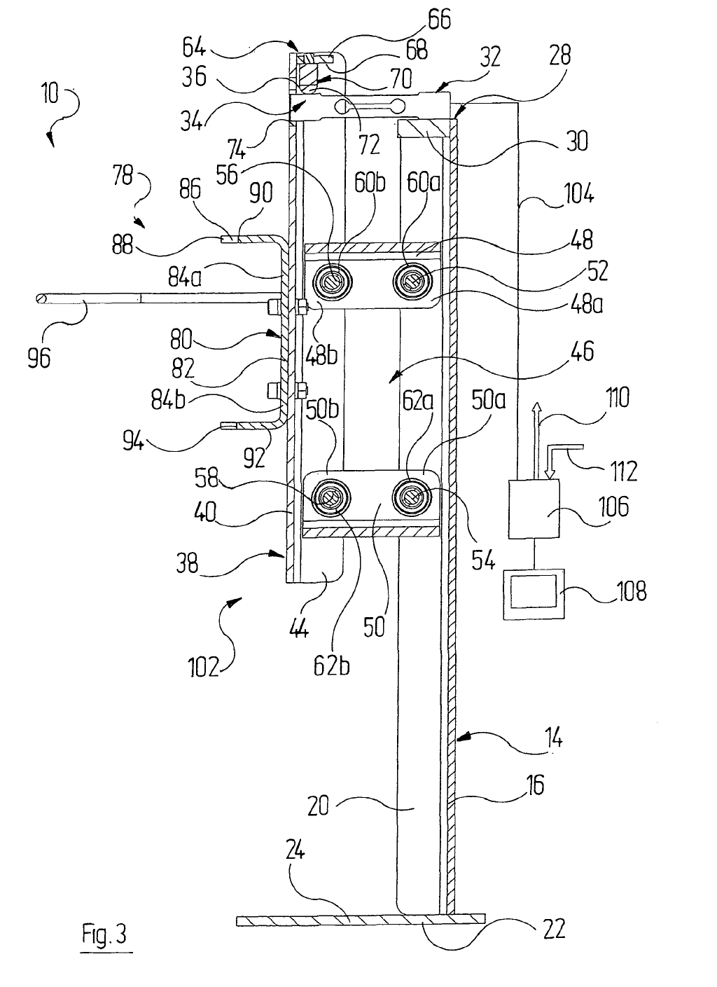

FIG. 3 a vertical section through the weighing device according to FIGS. 1 and 2, in which a load cell can be seen in a side view;

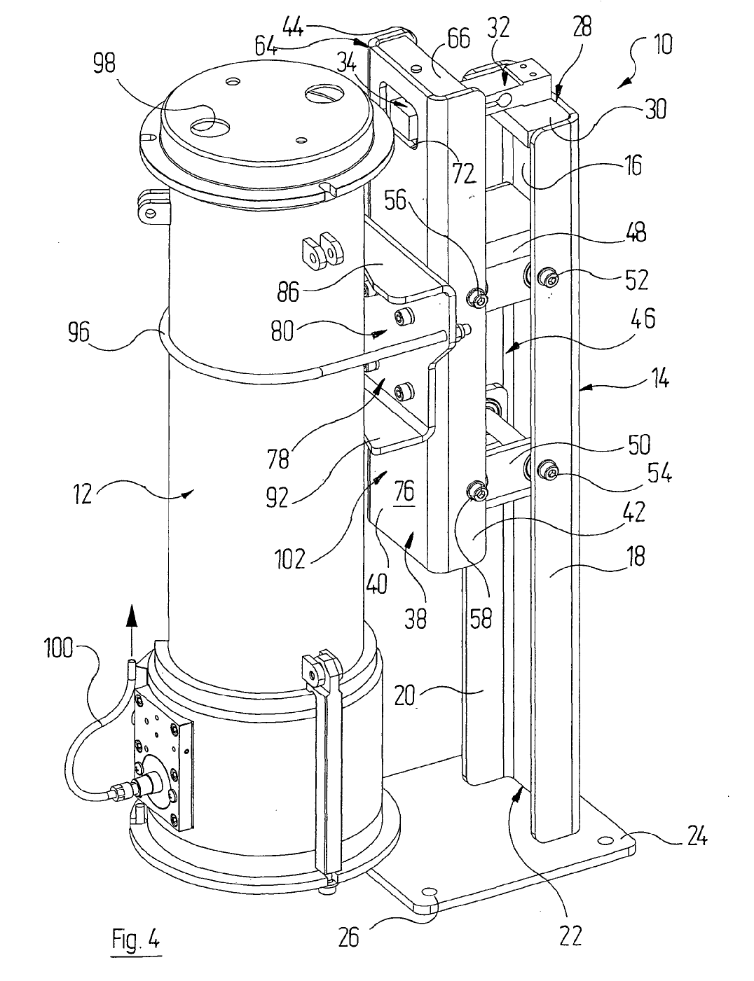

FIG. 4 a perspective view, similar to FIG. 1, of the weighing device, in which a storage tank for paint powder is supported by the weighing device;

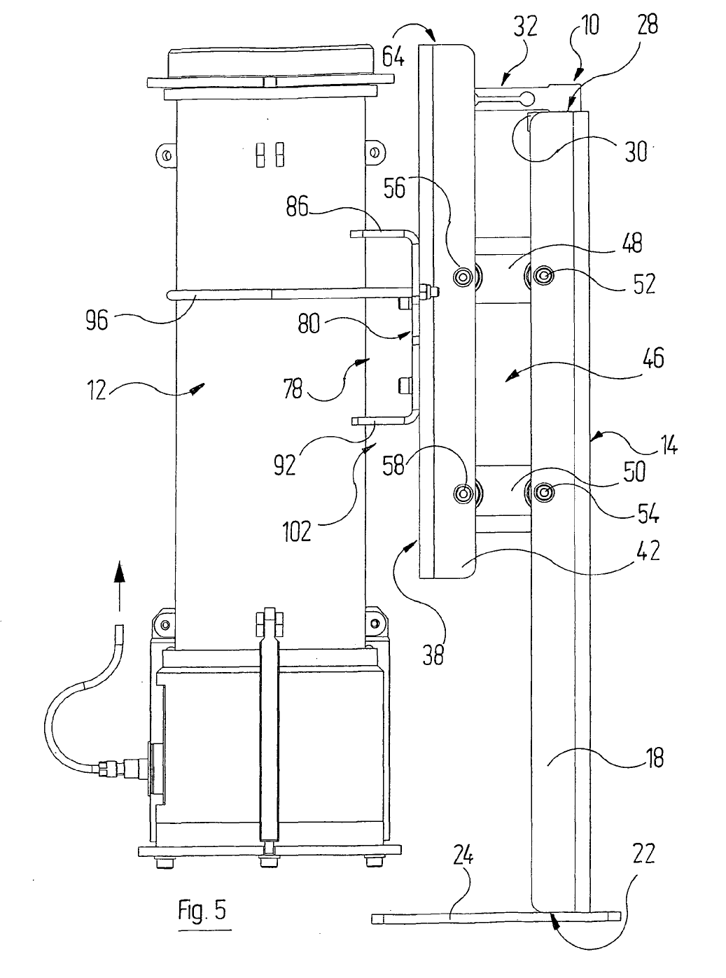

FIG. 5 a side view of the weighing device illustrated in FIG. 4 with a storage tank.

In FIG. 1, a weighing device for continuously weighing a storage tank 12 shown in FIGS. 4 and 5 is denoted as a whole by 10. The storage tank 12 is described again below.

The weighing device 10 comprises a U-shaped supporting profile 14 with a base limb 16 and two side cheeks 18 and 20 extending parallel thereto. At one end face 22, the supporting profile 14 is connected, for example welded, to a base plate 24 which extends at a right angle to the longitudinal axis of the supporting profile 14. In the exemplary embodiment shown here, the base plate 24 is substantially square and has through-bores 26 in its corner regions. Screws can be guided through these through-bores so that the base plate 24 can be fixed to the supporting profile 14 at a bottom face, thus preventing the weighing device 10 from tilting.

On its end face 28 which is opposite the base plate 24, an end wall 30, extending parallel to the base plate 24, is arranged between the side cheeks 18 and 20. On its planar upper face, the end wall 30 supports an elongated double bending beam load cell 32, which is known per se and has, in an end region 34, an upwardly facing measuring field 36 (c.f. FIG. 3). The measuring field here is the region of the load cell 32 on which the weight force to be measured has to be exerted in order to enable a measurement to be carried out. The load cell 32 generates output signals depending on the weight forces exerted on the measuring field 36. The load cell 32 is arranged such that its end region 34 with the measuring field 36 is remote from the supporting profile 14.

The weighing device 10 moreover comprises a U-shaped coupling profile 38 with a base limb 40 and two side cheeks 42, 44 extending perpendicularly to this latter. The coupling profile 38 has a cross-section which corresponds to that of the supporting profile 14, but is shorter than the supporting profile 14 in the longitudinal direction. The two profiles 14 and 38 extend parallel to one another and are aligned such that their respective side cheeks 18, 20 and 42, 44 face one another and are aligned with one another.

The two profiles 14 and 38 are movably connected to one another by way of a guide device 46. The guide device 46 is constructed as a parallelogram guide so that, with a movement of the coupling profile 38 relative to the supporting profile 14, their mutual parallel alignment is maintained.

To this end, the guide device 46 comprises an upper connecting rod 48 and a lower connecting rod 50 which is spaced from the upper connecting rod. These are each arranged with a first end region 48a and 50a between the side cheeks 18, 20 of the supporting profile 14 and with their respectively opposing second end region 48b and 50b between the side cheeks 42, 44 of the coupling profile 38. For clarity, the end regions 48a, 48b and 50a, 50b of the connecting rods 48, 50 are only indicated in FIG. 3.

In their first end region 48a, 50a, the upper connecting rod 48 and the lower connecting rod 50 are each connected in articulated manner to the supporting profile 14 by way of horizontally extending shafts 52 and 54 which are mounted on the side cheeks 18, 20 of the supporting profile 14 and extend between these two. In corresponding manner, in their second end regions 48b and 50b, the upper connecting rod 48 and the lower connecting rod 50 are pivotally mounted between the side cheeks 42, 44 of the coupling profile by way of horizontal shafts 56 and 58.

The upper connecting rod 48 and the lower connecting rod 50 have bearings 60a, 60b and 62a, 62b which are known per se and by means of which they may pivot with little friction about the horizontal shafts 52 to 58. For clarity, the bearings 60a, 60b and 62a, 62b are also only provided with reference numerals in FIG. 3.

In the present exemplary embodiment, the upper connecting rod 48 and the lower connecting rod 50 are constructed in a U shape, wherein the bearings 60a, 60b and 62a and 62b are arranged in the side cheeks (not provided specifically with a reference numeral here) which run parallel to one another and extend between the supporting profile 14 and the coupling profile 38. The supporting profile 14 and the coupling profile 38 are mutually aligned so that the coupling profile 38 projects upwards beyond the supporting profile 14 when it assumes an initial position in which the upper connecting rod 48 and the lower connecting rod 50 are horizontally aligned. This initial position of the coupling profile 38 is shown in FIGS. 1 to 5. The length of the connecting rods 48 and 50 is such that, in this initial position, a spacing is maintained between the supporting profile 14 and the coupling profile 38.

The end face 64 of the coupling profile 38 which is remote from the base plate 24 is closed by an end wall 66, wherein, in the initial position of the coupling profile 38, the measuring field 36 of the load cell 32 is arranged vertically below the end wall 66 and a spacing is maintained between its planar lower face 68 and the measuring field 36 of the load cell 32 (c.f. FIG. 3).

The end wall 66 of the coupling profile 38 supports a coupling pin 70 which projects perpendicularly downwards from the lower face 68 of the end wall and has a hemispherical bearing portion 72 at its end remote from the end wall 66 (see FIG. 3). The length of the coupling pin 70 corresponds to the spacing between the lower face 68 of the end wall 66 of the coupling profile 38 and the measuring field 36 of the load cell 32 in the initial position of the coupling profile 38. Thus, in the initial position of the coupling profile 38, the coupling pin 70 contacts the measuring field 36 of the load cell 32 directly with its bearing portion 72. The hemispherical bearing portion 72 of the coupling pin 70 ensures a minimal bearing surface.

In the present exemplary embodiment, the load cell 32 projects with its end region 34 slightly into a window-like material cutout 74 in the base limb 40 of the coupling profile 38. The window 74 is large enough for the coupling profile 38 to have a certain movement clearance.

On the outside 78 of its base limb 40 which is remote from the supporting profile 14, the coupling profile 38 supports a holding device 78 by means of which a paint powder storage tank 12 to be weighed (c.f. FIGS. 4 and 5) can be mounted on the coupling profile 38. The holding device 78 comprises a support element 80 which has a central plate-shaped portion 82 with which it abuts flat against the outside 76 of the base limb 40 of the coupling profile 38 and is screwed thereto. The plate-shaped portion 82 of the support element 80 has, in the direction of the window 74 of the coupling profile 38, a relatively wide region 84a in which it projects beyond the coupling profile 38 on both sides.

At the end of the relatively wide region 84a which faces towards the window 74 of the coupling profile 38, the plate-shaped portion 82 of the support element 80 merges into a first support cheek 86 which extends perpendicularly to the base limb 40 of the coupling profile 38 and whereof the outer edge 88 which is remote from the base limb 40 of the coupling profile 38 has a central recess 90 which is delimited by flanks extending symmetrically from the outside inwards in the direction of the base limb 40 of the coupling profile 38.

On the side remote from the first support cheek 86, the relatively wide region 84a of the plate-shaped portion 82 merges into a relatively narrow region 84b which is adjoined by a second support cheek 92 which likewise extends perpendicularly to the base limb 40 of the coupling profile 38 and has a recess 94 corresponding to the recess 90 of the first support cheek 86. The recesses 90 and 94 are aligned with one another in the vertical direction.

With its relatively wide region 84a, the support element 80 supports a holding bracket 96 whereof the curvature is adapted to the here circular outer contour of the storage tank 12. The holding bracket 96 projects with its free ends through the sub-regions of the relatively wide region 84a of the support element 80 which project laterally beyond the coupling profile 38, for which corresponding through-bores (not provided specifically with a reference numeral) are provided there. The end regions of the holding bracket 96 are provided with a thread and can be fixed to that side of the support element 80 which is remote from the support cheeks 86, 92 by means of nuts which are not provided specifically with a reference numeral. By turning the nuts accordingly, the holding bracket 96 can be drawn in the direction of the coupling profile 38, resulting in the storage tank 12 being pressed into the recesses 90, 93 of the support element 80 and being fixed in this position.

In FIGS. 4 and 5, the load cell 10 is shown with a storage tank 12 clamped in the holding device 78. To this end, the holding bracket 96 was firstly released from the support element 80. The storage tank 12 was held in a position in which it is located symmetrically in the recesses 90 and 94 of the support cheeks 86 and 92. Then the holding bracket 12 was pushed over the cylindrical wall of the storage tank 12 and pushed with its free end regions into the corresponding through-bores in the plate-shaped portion 84 of the support element 80 and screwed in place accordingly from the rear side. Here, the holding bracket 96 was drawn against the support element 80 by turning the nuts in such a way that the storage tank 12 is securely held by clamping.

The storage tank 12 is a storage tank of a powder delivery device which is known per se and of which the details are not of interest here. Paint powder is supplied to the storage tank 12 by way of a supply connection 98. This paint powder is fluidised inside the storage tank 12 in a manner known per se and is consequently removed in free-flowing manner from the storage tank 12 by way of a removal tube 100 and supplied to an application device (not illustrated here). Tubes and connections leading to or away from the storage tank 12 can be fixed to the supporting profile 14 without tension so that tubes and connections of this type do not affect the weighing result.

Together with the coupling profile 38 and the coupling pin 70, the holding device 78 forms a coupling device 102 which exerts a compressive force on the measuring field 36 of the load cell 32 which depends on the weight force of the storage tank 12 which is filled to a greater or lesser extent.

The coupling pin 70 presses on the measuring field 36 of the load cell 32 with a force which is determined by the weight of the storage tank 12 and the weight of the components belonging to the coupling device 102. The pressure exerted on the measuring field 36 causes the measuring cell 32 to generate output signals representing these compressive forces.

As a result of the guide device 46, the storage tank 12 is positively driven in terms of its movement, wherein it can move particularly in the vertical direction, i.e. with a vertical directional component. In the exemplary embodiment shown here, the movement of which the storage tank 12 is capable also comprises a horizontal directional component owing to the parallelogram guidance. However, this is of no importance to the compressive force exerted on the measuring field 36 of the load cell 32.

In the course of a coating procedure, the quantity of paint powder located in the storage tank 12 varies. Depending on the quantity of paint powder located in the storage tank 12, the pressure exerted on the measuring field 36 of the load cell 32 by way of the coupling element 70 also varies, as reflected in a correspondingly different output signal of the load cell 32.

As indicated in FIG. 3, the load cell 32 communicates with a control means 106 by way of a data line 104 which represents the signals emitted by the load cell 32 visually on a monitor 108.

If the output signal of the load cell 32 reflects a quantity of paint powder in the storage tank 12 which has fallen below a particular threshold value, the control means 106 initiates filling the storage tank 12 by way of its supply connection 98, as indicated in FIG. 3 by an arrow 110. Further operating parameters of the system are also relayed to the control means 106 used therein (arrow 112), whereby the control means 106 can be used to control the entire coating system which is capable of generating corresponding output signals for this purpose.

When filling the storage tank 12, the increase in its weight and therefore the status of the filling procedure can be followed by an operator using the visual representation on the monitor 108.

If paint powder from the storage tank 12 is applied to a vehicle body by means of the above-mentioned application device, an operator can follow the decrease in weight accordingly using the visual representation on the monitor 108.

From the data transmitted to the control means 106 from the load cell 32, the powder discharge quantity of the application device within a time-period specified by the operator can be calculated and displayed on the monitor 108. It is thus possible to determine with a high degree of precision how much paint powder has been applied to a particular vehicle body during the painting procedure. Knowing how much powder has been applied to each vehicle body in the course of a production stage helps to maintain a uniform paintwork quality for a plurality of painted vehicle bodies.

If the powder discharge quantity of the application device in a painting procedure is less or more than for a previous painting procedure, which changes—and generally worsens—the result of the paintwork by comparison with the previous painting procedure, the further painting process can, if wished, be interrupted immediately and exploratory measures can be undertaken to determine the reason for the change in the powder discharge quantity of the application device.

A change in the normal operating processes which influences the application quantity for each vehicle body is thus displayed immediately after it occurs without any time delays during which further vehicle bodies receive a coat of paint which may be of a lower quality than that of preceding vehicle bodies.

As a result of the weighing device 10, the quantity of paint powder in the storage tank 12 can be followed continuously or repeatedly at desired time intervals, for which only one load cell is required. There is no need for a complex alignment of the storage tank 12 or a plurality of lateral guides to stabilise the storage tank 12 against tilting with respect to a vertical axis.

Moreover, the measuring precision is greater than that of a weighing device which uses a plurality of load cells. With the weighing device 10, there is no need to establish a mean value which always involves a certain degree of imprecision. Instead, it is only necessary to analyse a single measuring result, which is directly representative of the quantity of paint powder present in the storage tank 12.

1. A device for continuously weighing powdered media in a tank, particularly paint powder in a storage tank, having a weighing unit, which has a measuring field on which a compressive force can be exerted and by means of which an output signal representing the compressive force exerted on the measuring field may be generated,
wherein the device comprises:
a) a guide device, which enables a positively driven movement of the tank with a vertical directional component;
b) a coupling device, by means of which the tank may be coupled in terms of force to the weighing unit so that a compressive force which is dependent on a weight force of the tank acts on the measuring field of the weighing unit when the tank is coupled to the weighing unit.

2. The weighing device of claim 1, wherein the coupling device or the guide device comprises a holding device for the tank.

3. The weighing device of to claim 2, wherein the coupling device is constructed as a substantially rigid structural unit the guide device of the coupling device enables the positively driven movement.

4. The weighing device of claim 1, wherein the guide device provides parallelogram guidance.

5. The weighing device of claim 1, wherein the coupling device comprises a coupling element which bears on the measuring field of the weighing unit by way of a bearing portion.

6. The weighing device of claim 5, wherein the bearing portion of the coupling element is curved.

7. The weighing device of claim 6, wherein the bearing portion of the coupling element is hemispherical.

8. The weighing device of claim 1, wherein the weighing unit is a double bending beam load cell.

9. The weighing device of claim 2, wherein the guide device provides parallelogram guidance.

10. The weighing device of claim 3, wherein the guide device provides parallelogram guidance.

11. The weighing device of claim 2, wherein the coupling device comprises a coupling element which bears on the measuring field of the weighing unit by way of a bearing portion.

12. The weighing device of claim 3, wherein the coupling device-comprises a coupling element which bears on the measuring field of the weighing unit by way of a bearing portion.

13. The weighing device of claim 4, wherein the coupling device-comprises a coupling element which bears on the measuring field of the weighing unit by way of a bearing portion.

14. The weighing device of claim 2, wherein the weighing unit is a double bending beam load cell.

15. The weighing device of claim 3, wherein the weighing unit is a double bending beam load cell.

16. The weighing device of claim 4, wherein the weighing unit is a double bending beam load cell.

17. The weighing device of claim 5, wherein the weighing unit is a double bending beam load cell.

18. The weighing device of claim 6, wherein the weighing unit is a double bending beam load cell.

19. The weighing device of claim 7, wherein the weighing unit is a double bending beam load cell.
